(19) United States
(12) Patent Application Publication
(10) Pub. No.: US 2026/0094177 A1
(43) Pub. Date: Apr. 2, 2026

(54) SYSTEMS AND METHODS FOR PRICE DETERMINATION

(71) Applicant: Cox Automotive, Inc., Atlanta, GA (US)

(72) Inventors: Connor Jones, Atlanta, GA (US); Jonathan Ye, Atlanta, GA (US); Udit Luthur, Kennesaw, GA (US)

(73) Assignee: Cox Automotive, Inc., Atlanta, GA (US)

(21) Appl. No.: 18/903,144

(22) Filed: Oct. 1, 2024

(51) Int. Cl. G06Q 30/0201; G06Q 10/083; G06Q 30/0204

(52) U.S. Cl. CPC G06Q 30/0206; G06Q 10/083; G06Q 30/0205

(57) ABSTRACT

Methods for determining a price for transporting a product are described. In one example, a method comprises receiving, by a computing device, a request to transport a product. The method further comprises determining, by the computing device, a first latitude and a first longitude and a second latitude and a second longitude, inputting, by the computing device, the first latitude, the first longitude, the second latitude, the second longitude, and the pick-up date into a first machine learning (ML) model, receiving, by the computing device from the ML model, a calculated price for transporting the product, receiving, by the computing device, input indicating adjustments to the calculated price for transporting the product, and adjusting, by the computing device, the calculated price based on the input, thereby resulting in a transportation price.

### BACKGROUND

Sellers of products commonly seek to ship their products to a different location. For example, a buyer may seek to buy a car, but it is located a location distant from them. The seller can acquire the services of a shipping entity, such as a truck transportation service, to move their product. To find the best price for shipping, sellers use the services of a broker that auctions the contract for shipping the product along a transportation route (i.e., the action of picking up the product and moving it to a remote location) to various shipping entities. These entities can either pick up the route for the posted price or sometimes offer a different price for shipping the product. Once a price is settled with a shipping entity, the shipping entity picks up the product and transports it to the selected destination. Determining a price for shipping a product requires considering many factors, which add to the complexity to determining an appropriate price for a broker to offer.

### BRIEF DESCRIPTION OF THE DRAWINGS

The accompanying drawings, which are incorporated in and constitute a part of this disclosure, illustrate various embodiments of the present disclosure. In the drawings:

FIG. 1 is a block diagram of an example operating environment for a price determination system;

FIG. 2 is a block diagram of an example price determination system;

FIG. 3 is a block diagram of example components for the machine learning model and second machine learning model of the price determination system;

FIG. 4 is a block diagram of an example table of historic pricing data used to train the machine learning model;

FIG. 5 is an example method for determining a price using the price determination system of FIG. 1;

FIG. 6 is an example method for determining training points that are relevant to the determined price of FIG. 5; and

FIG. 7 is a block diagram for an example computing device for operating one or more of the disclosed devices or systems herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The present disclosure relates to processes for determining a price for transporting a product from one location to another. Many factors can affect the price of transporting a product. For example, transporting a vehicle can depend on the pick-up location, drop-off location, and even product features such as the weight of the product. Further, the type of product can greatly affect the price. In one example, produce would need to be kept in a controlled climate. Other examples include transporting vehicles which requires a certain trailer for moving the vehicle long distances. Accordingly, the described system and methods use a machine learning (ML) model to determine a price to offer for transporting a product. Once a price is determined, the price can be posted where shipping entities can accept the contract. By using the ML model, the calculated price more accurately reflects the cost and increases the likelihood of being accepted by a shipping entity. The price is also better positioned for offering the lowest price for the shipper but still be accepted by a shipping entity, thus, increasing efficiency of the broker process. Once determined, the price can be further adjusted by other components.

Because of the numerous variables affecting the shipping process, offering a price that is acceptable to both the seller and shipping entity is important. The ML model is trained on a data set of past data points of shipping products. The ML model learns from the data set and can determine the most relevant data points for calculating a price of a current shipping route. For example, the ML model can compare past shipping instances with similar zip codes, weights, dates, or other aspects that indicate the shipping instances are relevant to the current shipping route. By grouping the past shipping instances of the training data set with methods such as gradient boosting tress (GBT), the system can calculate a well-positioned price for being accepted by a shipping entity without excessive costs to the seller. Moreover, additional ML models can be used for analyzing characteristics of the ML price prediction model. The additional ML models can be configured to determine the most relevant data training points that influenced or affect the calculation of the current price. These data training points provide insight into how the model is operating and helps build trust in the model.

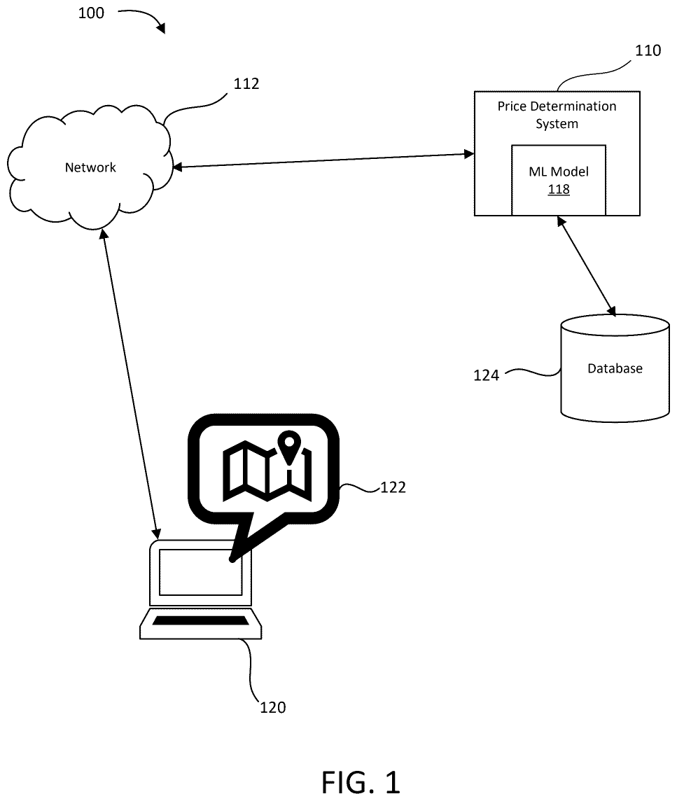

FIG. 1 illustrates an example environment of a system 100 for determining a price for shipping a product from one location to another. In this embodiment, system 100 includes price determination system 110 connected through network 112 to computing device 120. Computing device 120 displays a transportation route 122 including a price. Price determination system 110 also connects to database 124. Price determination system 110 includes a ML model 118 as well.

In the shown embodiment, price determination system 110 is configured to determine a price for shipping a product from a first location to a second location. Price determination system 110 uses ML model 118 to calculate the price. Further, price determination system 110 receives data about transportation route 122 and determines a price to offer shipping entities to transport the product. In some embodiments, price determination system 110 receives input describing aspects of the trip including a pick-up location, a drop-off location, a pick-up date, and a targeted drop-off date. The input may also describe product features such as a weight of the product, a type of product, and other features of the product. Further, price determination system 110 captures market trends for input into ML model 118 that determines prices for transporting products. Further, price determination system 110 uses a historical price data set stored in database 124 for training ML model 118.

Price determination system 110 is also configured to account for pricing changes due to geographic variations. For example, transporting to a location with higher gas prices and increased traffic may alter the determined price. In some embodiments, price determination system 110 converts the location of the pick-up and drop-off into a number format.

ML model 118 is configured to receive input data describing the transportation route and product, then output a determined price for offering a shipping entity. ML model 118 may also be a GBT machine learning model. In other embodiments, ML model 118 uses a different type of model.

In addition, ML model 118 receives a large amount of historical pricing data from database 124 and trains using the historical pricing data. In some embodiments, ML model 118 trains using supervised learning and the historical pricing data is labeled with the final price for shipping the product in that particular instance.

Computing device 120 provides the functionality of requesting a price for transporting a product. Computing device 120 is configured to receive input indicating a request for transportation of a product. Using a broker application, API call, or other communication means, computing device 120 requests a price from the price determination system 110. For example, computing device 120 requests a price for transporting a product according to transportation route 122. Price determination system 110 uses ML model 118 to determine a price. The price is then sent to computing device 120. In some embodiments, computing device 120 may then post the price to a broker application. Shipping entities can then accept the price and agree to transport the product between the indicated locations.

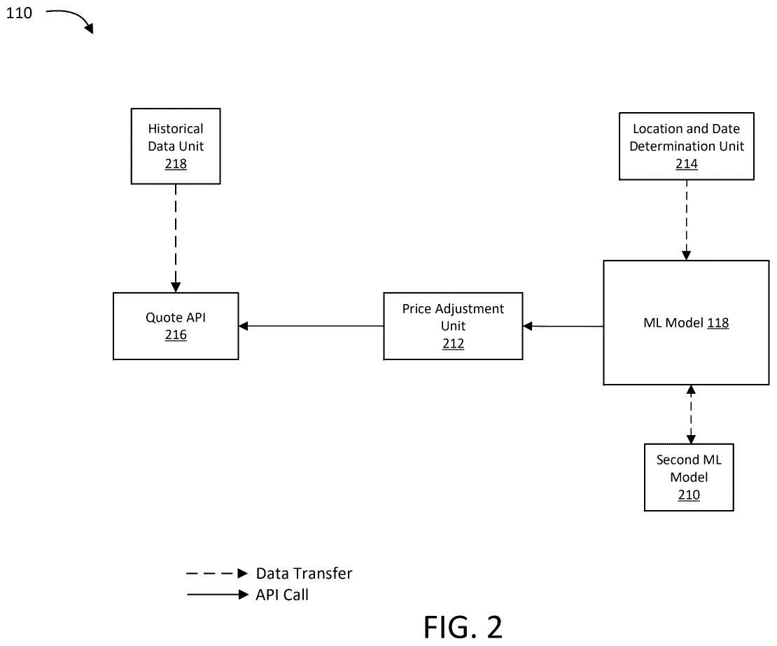

FIG. 2 illustrates components of price determination system 110. Price determination system 110 includes a quote API 216 that calls a price adjustment unit 212 and ML model 118. The ML model 118 receives data from a location and date determination unit 214. Further, the ML model 118 exchanges data and connects to the second ML model 210. Further, the quote API 216 receives data from a historical data unit 218.

Quote API 216 is configured to provide determined prices based on a call from price adjustment unit 212. The determined prices may include carrier prices (or also referred to as a transportation price) as the offered price for transporting a product to a shipping entity; or it may include a retail price as the cost offered to a user (e.g., seller of a product) of price determination system 110 that requires a product to be moved. Accordingly, the retail price minus the carrier price indicates an amount of profit as a broker fee. Quote API 216 also receives data from historical data unit 218, which may include prices for past listings of the same or similar vehicles.

Price adjustment unit 212 provides the functions of altering prices that are offered to sellers and carriers. Further, price adjustment unit 212 receives data from ML model 118. In some embodiments, price adjustment unit 212 provides a separate retail and carrier price.

Historical Data unit 218 provides customer data to quote API 216. The customer data may include data about sellers that affects the prices. For example, the seller may have past retail prices that they are willing to pay for using price determination system 110 to organize shipping of the seller's product. In addition, historical data unit 218 provides past prices for the particular product that is being shipped. In some embodiments, the product is a vehicle. The past prices include product features data about the type of vehicle such as, make, model, year, and weight. Other data about the product may be included as well.

Historical data unit 218 also provides past listings of the product and the associated retail price and the carrier price for that particular listing. In addition, historical data unit 218 may store past listings from a particular broker and other brokers that have offered listings to ship the same or similar product. Further, the past listings may use the same or similar pick-up and drop-off locations.

Once a listing is adjusted and offered, price adjustment unit 212 may also send the prices to historical data unit 218 for storage. Historical data unit 218, thus, continues to build its database of past listings for future adjustment of prices. In some embodiments, these past listings may be sent to database 124 for storage and training of ML model 118 for determining prices.

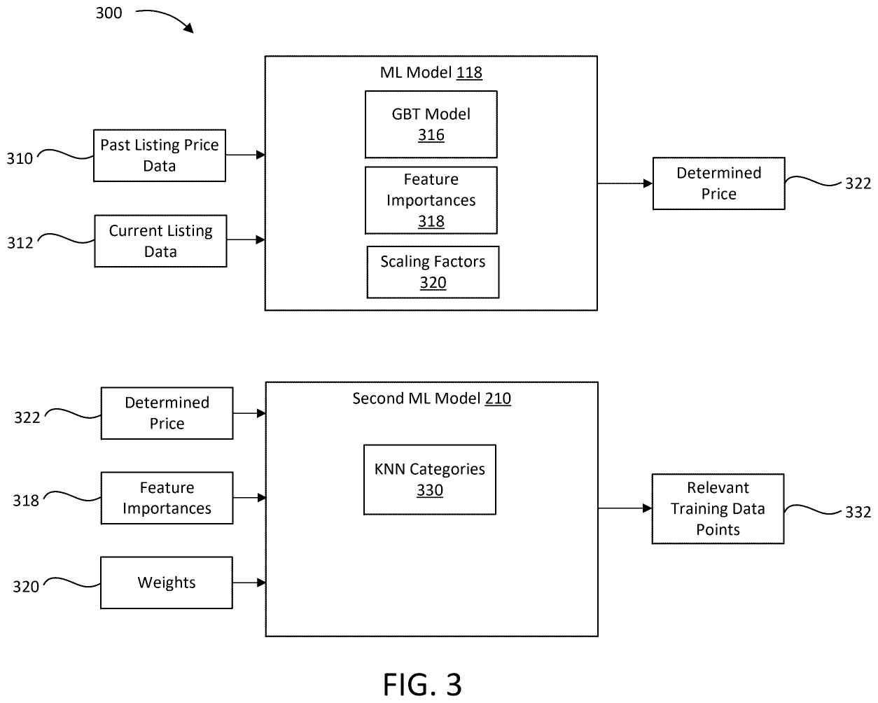

In the shown embodiment, second ML model 210 is configured to calculate relevant training data points used by ML model 118 to determine a particular price (e.g., the retail price and/or the carrier price). Second ML model 210 is configured to help explain the price of ML model 118. Further, metadata from ML model 118 is used to scale the data in finding the most relevant points. More details of second ML model 210 are discussed with reference to FIG. 3.

FIG. 3 illustrates example inputs and outputs of ML model 118 and second ML model 210. In this embodiment, ML model 118 includes a GBT model 316, feature importances 318 and scaling factors 320. In addition, ML model 118 receives past listing price data 310 and current listing data 312. ML model 118 also outputs determined prices 322. Second ML model 210 receives feature importances 318 and scaling factors 320 from the ML model 118. Further, second ML model 210 outputs the relevant training data points 332.

Past listing price data 310 is the training data used by ML model 118. Past listing price data 310 may be stored in database 124. Current listing data 312 includes data related to the current listing for which price determination system 110 is to determine a price. For example, current listing data 312 may include a product type, a drop-off location, and a pick-up location. In some embodiments where the product is a vehicle, the current listing data 312 includes make, model, year, and weight.

In this embodiment, ML model 118 includes GBT model 316. GBTs are a ML technique used for both regression and classification tasks. They are an ensemble method, meaning they combine the predictions of multiple models to achieve high performance. In some embodiments, these models begin with a decision tree with a few splits. The GBT then builds subsequent models sequentially. Each new model focuses on correcting the errors made by the previous models. This is done by giving more weight to the data points that were misclassified or had large residuals in previous iterations. The process of finding the best model to correct the errors of the previous ones is guided by gradient descent. Gradient descent is an optimization algorithm that helps find the direction and magnitude of change that will most reduce the model's error. The final prediction is a weighted combination of the predictions of all the individual models. The weights are determined during the boosting process, with models that perform better on the training data receiving higher weights. Example GBT models include XGBoost, LightGMB, and CatBoost.

Further, ML model 118 generates feature importances 318 and scaling factors 320. Feature importances 318 are scores assigned to input features based on how useful they are in predicting the target variable. These scores help understand which features are most relevant to the model's decision-making process. Feature importances 318 provides insights into how the model works, which may make it easier to explain predictions and gain insights into the underlying relationships in the data. Identifying the important features can help with feature selection, where choosing a subset of features simplifies the model, potentially improving its efficiency and performance. In some embodiments, ML model 118 calculates feature importances 318 by recording ML model 118's performance each time a feature is used to split a node in a decision tree. The feature's importance is then calculated as the total improvement it provides across all trees in the ensemble. Other methods of calculating feature importances 318, such as gain-based importance and permutation importance, may be used as well.

Scaling factors 320 are multipliers of feature importances 318. ML model 118 uses scaling factors 320 to indicate the significance of each feature importance 318 in calculating determined price 322 for the current listing associated with current listing data 312.

ML model 118 produces the determined price 322. Determined price 322 corresponds to current listing data 312. In some embodiments, determined price 322 includes a retail price and a carrier price. Determined price 322 indicates prices the seller and carrier will likely accept. In some embodiments, adjustments are applied by some of the previously described components in FIG. 2.

Second ML model 210 receives the feature importances 318, scaling factors 320, and determined price 322 for calculating relevant training data points 332. In some embodiments, second ML model 210 uses nearest neighbors as a model. The nearest neighbors model, also known as k-nearest neighbors (KNN), is a machine learning algorithm used for both classification and regression tasks. It operates under the principle that similar data points tend to be located near each other. Further, it is an unsupervised learning model. After receiving the appropriate inputs from ML model 118, second ML model 210 calculates the most relevant data points in determining the particular price by ML model 118. Using this model, second ML model 210 generates KNN categories 330. The KNN categories indicate groups for the training points used based on similarities of the data, such as location, weight, type of product, etc. Using these categories, the second ML model 210 produces relevant training data points 332 used to determine the determined price 322.

In some embodiments, relevant training data points 332 produces a predetermined number of training data points. Relevant training data points 332 indicate the training data points from a training set that were the most relevant for producing determined price 322. Relevant training data points 332 can be evaluated to determine the accuracy of ML model 118. For example, if relevant training data points 332 indicate outlier data points were the most relevant that would not normally be considered relevant, then ML model 118 can be adjusted to address the issue.

Location and date determination unit 214 provides location data from historical listings data stored in database 124 to ML model 118. In one embodiment, location and date determination unit 214 converts location data into a processable number for training ML model 118. For example, the hierarchical nature of interpreting a zip code from left to right can be used. The zip code, generally, becomes more precise in location with the left most digit being the most general, while the right most digit is the most specific in identifying a location. For example, finding previous prices for shipping a product can be found for a location by searching for locations with the same first three digits of a zip code. The search can be expanded by moving up in zip code digits.

In another embodiment, the latitude and longitude of a point within the zip code is used. The latitude and longitude in the center of the zip code may be used to encode the zip code to a number. Then, the zip codes may be used to determine previous prices that are similar to the current price determination instance by comparing zip codes with close latitude and longitude numbers. The latitude and longitude for each of the pick-up location and the drop-off location may be included as data associated with a past price for a transportation route. Other geographic comparison methods may be used as well. Once converted, location and date determination unit 214 provides the converted location data to ML model 118.

In an example of considering the latitude and the longitude of a drop-off location and a pick-up location, the price determination system 110 receives data associated listings on each side of the latitude line and the longitude line. Using this information, the ML model 118 can determine a price for transporting the product, such as a car. Accordingly, the latitude and longitude are used to extrapolate a price for transporting a product to a location between the data listings around the latitude and longitude point of the drop-off and pick-up locations. This ability results from the inherent hierarchy of latitude and longitude. In some embodiments, ML model 118 using the data points surrounding the latitude and longitude improves predictions about an area that may lack sufficient data points.

Further, the ML model 118 may use a hierarchy of each digit in a zip code of the pick-up location and the drop-off location as previously described. If data is not available for a specific zip code, the ML model 118 can use data points for a similar zip code that shares some digits of the desired zip code, such as sharing the first three numbers but differing the last three numbers, to predict a price point. In some embodiments, the ML model 118 uses one or more digits of the zip code to find data points that share the one or more digits of the zip code.

In addition, location and date determination unit 214 converts the date of the historical listing data to an integer in some embodiments. To start, a predetermined date is selected. This may be the earliest date for which the historical listing data dates. Once selected, location and date determination unit 214 calculates a number of days since the predetermined date for each listing. The calculated number of days is then selected as the integer representing the date of the listing of the historical listings. This integer may then be provided to ML model 118.

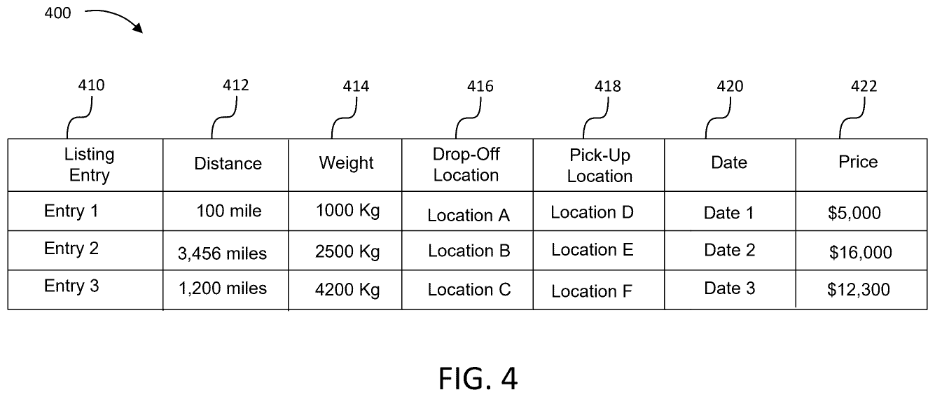

FIG. 4 illustrates a historical pricing table 400. Historical pricing table 400 includes listing entries 410, distance entries 412, weight entries 414, drop-off location entries 416, pick-up location entries 418, date entries 420, price entries 422.

Here, historical pricing table 400 includes entries for historical pricing data. The historical pricing data may be collected by a broker application that is configured to connect shipping entities with sellers wishing to ship a product. The historical pricing data within database 124 and can be used as input to ML model 118 to train ML model 118, where price entries 422 may be considered labels. Further, the historical pricing data may include relevant features of the product and transportation route such as pick-up location, drop-off location, distance, whether the transportation is enclosed, the product weight. In some embodiments, the historical pricing data is for shipping vehicles and includes product features such as make, model, and year. Additional product features include size or color of the vehicle. Other data entries describing a listing may be included as well.

In this embodiment, listing entries 410 indicates an index for a particular listing. It enables for searching of a listing database within database 124. Distance entries 412 indicates the distance between the pick-up location and the drop-off location. A longer distance may contribute to a higher price when determining a price.

Weight entries 414 indicate the weight of the product. In some embodiments, the weight may indicate the weight of a product vehicle. Drop-off location entries 416 and pick-up location entries 418 indicate locations the product is picked up and transported to for drop-off. In some embodiments, both entries include a zip code. Further, drop-off location 416 and pick-up location 418 may include a latitude and longitude that is within the zip code, such as in the center of the zip code. Date entries 420 include dates for the transportation of the product in that listing. In some embodiments, date entries 420 include a date for when the product was picked up and when the product was dropped off.

Price entries 422 indicate an accepted price for that listing. Further, price entries 422 may include a retail price and a carrier price. Price entries 422 may also be used as labels for training the ML model 118. In some embodiments, price entries 422 were determined by ML model 118. In other embodiments, price entries 422 were adjusted before being listed. In even other embodiments, price entries 422 were manually determined.

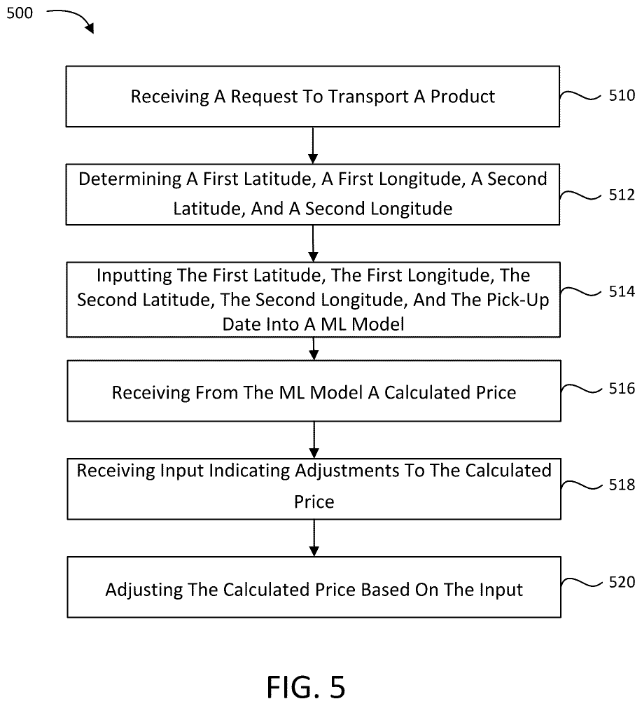

FIG. 5 illustrates an example method 500 for determining a price for transporting a product using the system 100 of FIG. 1. In some embodiments, price determination system 110 performs all or some of the indicated operations of method 500.

At operation 510, a request to transport a product is received. The request may include a pick-up location, a drop-off location, a weight of the product, a pick-up date, or other aspects that describe the product. Proceeding to operation 512 a first latitude and a first longitude of pick-up location and a second latitude and a second longitude of the drop-off location are determined. This determination may be based on received input data with the request to transport the product. In some embodiments, the pick-up date is converted into an integer by calculating a number of days since a predetermined date of a data set.

At operation 514, the first latitude, the first longitude, the second latitude, the second longitude, and the pick-up date are inputted into a first ML model, for example, ML model 118. The first ML model may be configured to determine a price that is likely to be accepted by sellers and a price that will be accepted by shipping entities. In some embodiments, the first ML model calculates a price for transporting the product. Proceeding to operation 516, a calculated price is received from the first ML model. At operation 518, input indicating adjustments to the calculated price are received. These adjustments may decrease or increase the calculated price. Proceeding to operation 520, the calculated price is adjusted based on the input. These adjustments may result in a transportation price (i.e., carrier price).

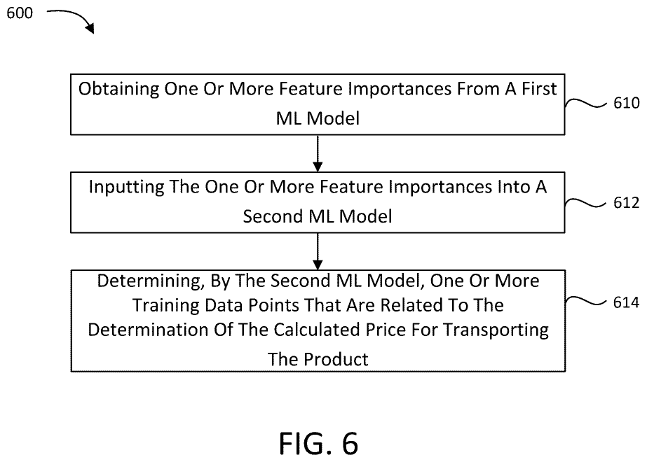

FIG. 6 illustrates an example method 600 for using the second ML model 210 for determining relevant training points related to a price determination. In some embodiments, price determination system 110 may perform all or some of the listed operations of method 600. All or some of the listed operations of method 600 may be performed in conjunction with method 500.

At operation 610, one or more feature importances are obtained from a first ML model. In some embodiments, the first ML model is ML model 118. Further, the feature importances may indicate how significant a particular feature of the data set was to the output of a model. Proceeding to operation 612, the one or more feature importances are inputted into a second ML model. In some embodiments, the second ML model is the ML model 210. At operation 614, one or more training data points that are related to the determination of the calculated price for transporting the product are determined by the second ML model. These training data points may indicate which historic listings contributed the most to determining the calculated price.

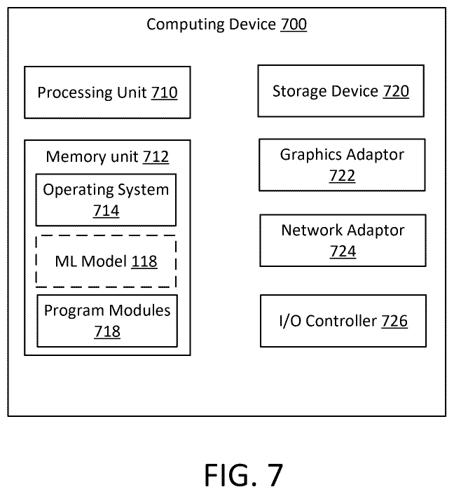

FIG. 7 illustrates an example computing device for performing one or more of the described operations. As shown in FIG. 7, computing device 700 includes a processing unit 710 and a memory unit 712. Memory unit 712 includes an operating system 714 and a program module 718. Optionally, memory unit 812 includes ML model 118 or second-ML model 210. Memory unit 712 stores non-transitory instructions for causing the computing device 700 to perform the certain operations, such as the methods 500 or 600. Operating system 712 provides an interface for the program modules to interact with other hardware components of computing device 700. While executing on processing unit 710, program modules 718 performs, for example, any one or more of the stages from methods 500 or 600 described above with respect to FIGS. 6 and 7, respectively. Computing device 700, for example, provides an operating environment for price determination system 110 or computing device 120. Further, computing device 700 includes a storage device 720. Storage device 720 may be a non-transitory computer-readable medium including instructions for performing certain operations. Storage device 720 may be removable or permanently installed. Graphics adaptor 722 is configured to interface with a display device and compute complex calculations for displaying certain data. Graphics adaptor 722 may also be configured to process other data as well. Network adaptor 724 is configured to connect computing device 700 to a network or other devices. For example, it may connect over Wi-Fi, Bluetooth, ethernet, or other wireless or wired connections. I/O controller 726 provides an interface for interacting with devise that provide input, such as keyboards, pointing devices, cameras, and the like. Also, I/O controller 726 interfaces with output devices such as speakers, USB devices, or other output devices. These listed systems and devices may operate in other environments and are not limited to computing device 700.

Computing device 700 can be implemented using a tablet device, a mobile device, a smart phone, a telephone, a remote control device, a personal computer, a network computer, a mainframe, a router, a switch, a server cluster, a smart TV-like device, a network storage device, a network relay device, or other similar microcomputer-based device. Computing device 700 can include any computer operating environment, such as hand-held devices, multiprocessor systems, microprocessor-based or programmable sender electronic devices, minicomputers, mainframe computers, and the like. Computing device 700 can also be practiced in distributed computing environments where tasks are performed by remote processing devices. The aforementioned systems and devices are examples and computing device 700 can comprise other systems or devices.

Embodiments of the disclosure, for example, can be implemented as a computer process (method), a computing system, or as an article of manufacture, such as a computer program product or computer readable media. The computer program product can be a computer storage media readable by a computer system and encoding a computer program of instructions for executing a computer process. The computer program product can also be a propagated signal on a carrier readable by a computing system and encoding a computer program of instructions for executing a computer process. Accordingly, the present disclosure can be embodied in hardware and/or in software (including firmware, resident software, micro-code, etc.). In other words, embodiments of the present disclosure can take the form of a computer program product on a computer-usable or computer-readable storage medium having computer-usable or computer-readable program code embodied in the medium for use by or in connection with an instruction execution system. A computer-usable or computer-readable medium can be any medium that can contain, store, communicate, propagate, or transport the program for use by or in connection with the instruction execution system, apparatus, or device.

The computer-usable or computer-readable medium can be, for example but not limited to, an electronic, magnetic, optical, electromagnetic, infrared, or semiconductor system, apparatus, device, or propagation medium. More specific computer-readable medium examples (a non-exhaustive list), the computer-readable medium can include the following: an electrical connection having one or more wires, a portable computer diskette, a Random Access Memory (RAM), a Read-Only Memory (ROM), an Erasable Programmable Read-Only Memory (EPROM or Flash memory), an optical fiber, a portable Compact Disc Read-Only Memory (CD-ROM), and a portable pen drive. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIGS. 1, 2, and 3 may be integrated onto a single integrated circuit. Such a SOC device may include one or more processing units, graphics unit, communications units, system virtualization units and various application functionality all of which may be integrated (or “burned”) onto the chip substrate as a single integrated circuit. When operating via a SOC, the functionality described herein with respect to embodiments of the disclosure, may be performed via application-specific logic integrated with other components of computing device 700 on the single integrated circuit (chip).

In a first example, a method comprises receiving, by a computing device, a request to transport a product. The request includes a pick-up location, a drop-off location, and a pick-up date. The method further comprises determining, by the computing device, a first latitude and a first longitude of the pick-up location and a second latitude and a second longitude of the drop-off location, inputting, by the computing device, the first latitude, the first longitude, the second latitude, the second longitude, and the pick-up date into a first machine learning (ML) model, receiving, by the computing device from the ML model, a calculated price for transporting the product, receiving, by the computing device, input indicating adjustments to the calculated price for transporting the product, and adjusting, by the computing device, the calculated price based on the input, thereby resulting in a transportation price.

In a second example, a system comprises a memory storage; and a processing unit, the processing unit disposed in a station and coupled to the memory storage. The processing unit is operative to receive a request to transport a product. The request including a pick-up location, a drop-off location, and a pick-up date. The processing unit is further operative to determine a first latitude and a first longitude of the pick-up location and a second latitude and a second longitude of the drop-off location, input the first latitude, the first longitude, the second latitude, the second longitude, and the pick-up date into a first machine learning (ML) model, receive, from the ML model, a calculated price for transporting the product, receive input indicating adjustments to the calculated price for transporting the product, and adjusting the calculated price based on the input, thereby resulting in a transportation price.

In a third example, a non-transitory computer-readable medium stores a set of instructions which when executed perform a method executed by the set of instructions that comprises receiving, by a computing device, a request to transport a product. The request including a pick-up location, a drop-off location, and a pick-up date. The set of instructions further comprises determining, by the computing device, a first latitude and a first longitude of the pick-up location and a second latitude and a second longitude of the drop-off location, inputting, by the computing device, the first latitude, the first longitude, the second latitude, the second longitude, and the pick-up date into a first machine learning (ML) model, receiving, by the computing device from the ML model, a calculated price for transporting the product, receiving, by the computing device, input indicating adjustments to the calculated price for transporting the product, and adjusting, by the computing device, the calculated price based on the input, thereby resulting in a transportation price.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
converting, by a computing device, zip codes of pick-up locations and drop-off locations of historical pricing data into latitudes and longitudes of the pick-up locations and the drop-off locations of the historical pricing data;
inputting, by the computing device, the historical pricing data that includes the latitudes and the longitudes of the pick-up locations and the drop-off locations into a first machine learning (ML) model;
training, by the first ML model, based on the historical pricing data;
receiving, by the computing device, a request to transport a product, the request including a pick-up location, a drop-off location, and a pick-up date;
determining, by the computing device, a first latitude and a first longitude of the pick-up location and a second latitude and a second longitude of the drop-off location;
inputting, by the computing device, the first latitude, the first longitude, the second latitude, the second longitude, and the pick-up date into the first ML model;
determining, by the first ML model, a calculated price for transporting the product, the determining of the calculated price including:
comparing the first latitude, the first longitude, the second latitude, and the second longitude to the latitudes and the longitudes of the pick-up locations and the drop-off locations of the historical pricing data, and
extrapolating the calculated price for the pick-up location and the drop-off location from one or more pick-up locations and one or more drop-off locations, from the historical pricing data, located one each side of the first latitude, the first longitude, the second latitude, and the second longitude;
receiving, by the computing device from the first ML model, the calculated price for transporting the product;
receiving, by the computing device, input indicating adjustments to the calculated price for transporting the product; and
adjusting, by the computing device, the calculated price based on the input, thereby resulting in a transportation price.

2. The method of claim 1, further comprising:
obtaining, by the computing device, one or more feature importances from the ML model;
inputting, by the computing device, the one or more feature importances into a second ML model; and
determining, by the second ML model, one or more training data points that are related to a calculation of the calculated price for transporting the product.

3. The method of claim 2, wherein the second ML model is a nearest-neighbors model.

4. The method of claim 2, wherein the one or more training data points have a highest weight in determining the calculated price for transporting the product.

5. The method of claim 2, further comprising:
providing, by the computing device, the one or more training data points.

6. The method of claim 1, further comprising:
converting, by the computing device, the pick-up date into an integer by calculating a number of days since a predetermined date of a data set.

7. The method of claim 1, wherein the ML model is a gradient boosting tree model.

8. The method of claim 1, further comprising:
adding, by the computing device, a percentage to the transportation price, thereby resulting in a retail price; and
providing, by the computing device, the retail price to a second computing device.

9. A system comprising:
a memory storage; and
a processing unit, the processing unit disposed in a station and coupled to the memory storage, wherein the processing unit is operative to:
convert zip codes of pick-up locations and drop-off locations of historical pricing data into latitudes and longitudes of the pick-up locations and the drop-off locations of the historical pricing data;
input historical pricing data that includes the latitudes and the longitudes of the pick-up locations and the drop-off locations into a first machine learning (ML) model;
train the first ML model based on the historical pricing data;
receive a request to transport a product, the request including a pick-up location, a drop-off location, and a pick-up date;
determine a first latitude and a first longitude of the pick-up location and a second latitude and a second longitude of the drop-off location;
input, by the computing device, the first latitude, the first longitude, the second latitude, the second longitude, and the pick-up date into the first ML model;
use the first ML model to determine a calculated price for transporting the product. wherein determine the calculated price includes use the first ML model to:
compare the first latitude, the first longitude, the second latitude, and the second longitude to the latitudes and longitudes of the pick-up locations and the drop-off locations of the historical pricing data, and
extrapolate the calculated price for the pick-up location and the drop-off location from one or more pick-up locations and one or more drop-off locations, from the historical pricing data, located one each side of the first latitude, the first longitude, the second latitude, and the second longitude;
receive, from the ML model, a calculated price for transporting the product;
receive input indicating adjustments to the calculated price for transporting the product; and
adjusting the calculated price based on the input, thereby resulting in a transportation price.

10. The system of claim 9, wherein the processing unit is further operative to:
obtain one or more feature importances from the ML model;
input the one or more feature importances into a second ML model; and
determine, by the second ML model, one or more training data points that are related to a calculation of the calculated price for transporting the product.

11. The system of claim 10, wherein the second ML model is a nearest-neighbors model.

12. The system of claim 10, wherein the one or more training data points have a highest weight in determining the calculated price for transporting the product.

13. The system of claim 10, wherein the processing unit is further operative to:
provide the one or more training data points.

14. The system of claim 9, wherein the processing unit is further operative to:
convert the pick-up date into an integer by calculating a number of days since a predetermined date of a data set.

15. The system of claim 9, wherein the ML model is a gradient boosting tree model.

16. The system of claim 9, wherein the processing unit is further operative to:
add a percentage to the transportation price, thereby resulting in a retail price; and
provide the retail price to a second computing device.

17. A non-transitory computer-readable medium that stores a set of instructions which when executed perform a method executed by the set of instructions comprising:
converting, by a computing device, zip codes of pick-up locations and drop-off locations of historical pricing data into latitudes and longitudes of the pick-up locations and the drop-off locations of the historical pricing data;
inputting, by the computing device, historical pricing data that includes the latitudes and the longitudes of the pick-up locations and the drop-off locations into a first machine learning (ML) model;
training, by the first ML model, based on the historical pricing data;
receiving, by the computing device, a request to transport a product, the request including a pick-up location, a drop-off location, and a pick-up date;
determining, by the computing device, a first latitude and a first longitude of the pick-up location and a second latitude and a second longitude of the drop-off location;
inputting, by the computing device, the first latitude, the first longitude, the second latitude, the second longitude, and the pick-up date into the first ML model;
determining, by the first ML model, a calculated price for transporting the product, the determining of the calculated price including:
comparing the first latitude, the first longitude, the second latitude, and the second longitude to the latitudes and the longitudes of the pick-up locations and the drop-off locations of the historical pricing data, and
extrapolating the calculated price for the pick-up location and the drop-off location from one or more pick-up locations and one or more drop-off locations, from the historical pricing data, located one each side of the first latitude, the first longitude, the second latitude, and the second longitude;
receiving, by the computing device from the ML model, a calculated price for transporting the product;
receiving, by the computing device, input indicating adjustments to the calculated price for transporting the product; and
adjusting, by the computing device, the calculated price based on the input, thereby resulting in a transportation price.

18. The non-transitory computer-readable medium of claim 17, wherein the set of instructions further comprises:
obtaining, by the computing device, one or more feature importances from the ML model;
inputting, by the computing device, the one or more feature importances into a second ML model; and
determining, by the second ML model, one or more training data points that are related to a calculation of the calculated price for transporting the product.

19. The non-transitory computer-readable medium of claim 18, wherein the one or more training data points have a highest weight in determining the calculated price for transporting the product.

20. The non-transitory computer-readable medium of claim 17, wherein the set of instructions further comprises:
adding, by the computing device, a percentage to the transportation price, thereby resulting in a retail price; and
providing, by the computing device, the retail price to a second computing device.
